(19) United States
(12) Patent Application Publication
(10) Pub. No.: US 2005/0145202 A1
(43) Pub. Date: Jul. 7, 2005

(54) Rigid dog leash

(76) Inventor: James Bonner, Akron, OH (US)

Correspondence Address: Law Offices of John D. Gugliotta, PE, Esq., 202 Delaware Building, 137 South Main Street, Akron, OH, 44308, US

(21) Appl. No.: 11/029,579

(22) Filed: Jan. 5, 2005

Related U.S. Application Data
(60) Provisional application No. 60/534,132, filed on Jan. 5, 2004.

(51) Int. Cl. A01K 27/00

(52) U.S. Cl. 119/792

(57) ABSTRACT

An animal harness and leash combination is provided having an animal harness for circumscribing the torso of an animal. A pivoting attachment element is affixed to the upper portion of the animal harness and supports an extension arm rotatably affixed to a pivoting attachment. A leash is then capable of being removably attached to the vertically extended pivoting attachment to allow the leash to remain above the animal, thereby eliminating the possibility that the leash will become entangled with the animal's legs.

### RELATED APPLICATIONS

The present invention claims the benefit of U.S. Provisional Patent No. 60/534132, filed on Jan. 05, 2004 and incorporated by reference as if fully rewritten herein.

### BACKGROUND OF THE INVENTION

1. Field of the Invention

The present invention relates generally to animal leashes and, more particularly, to a rigid animal harness and leash combination.

2. Description of the Related Art

When a dog is taken for a walk, often times the pace and gait of animal and owner remain asynchronous, resulting in variations in slackness and tension of the leash. This can often lead to the leash dragging the ground or tangling among the animal's four legs or the owners two legs. In the past, the only ways that this problem has been address is either through diligent manipulation by the owner, or through the use of a retractable leashing system that provides a spring return tension to automatically rewind the leash. However, the first system is not always active, while the second system has a number of problems. These include having constant tension on the animal, or, if the retracting means is locked to avoid such tension, results in the complete, but temporary, negating of the entire system.

What is lacking in the above-cited examples is a means for holding the leash above the body of the animal altogether, thereby making the geometry such as to eliminated, or greatly reduce the chances that the leash will drag below the animal's feet. The current invention provides such a means.

### SUMMARY OF THE INVENTION

It is therefore an object of the present invention to provide an improved animal leash system.

It is a feature of the present invention to provide an improved animal leash system that incorporates a rigid, vertically extendable animal harness for attachment of the leash.

Briefly described according to one embodiment of the present invention, an animal harness and leash combination is provided having an animal harness for circumscribing the torso of an animal. A pivoting attachment element is affixed to the upper portion of the animal harness and supports an extension arm rotatably affixed to a pivoting attachment. A leash is then capable of being removably attached to the vertically extended pivoting attachment to allow the leash to remain above the animal, thereby eliminating the possibility that the leash will become entangled with the animal's legs.

An advantage of the present invention is that is allows the leash to remain above and behind the neck of the animal, thereby eliminating the possibility that the leash will become entangled with the animal's legs.

### BRIEF DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1 is a perspective view of the preferred embodiment of a rigid animal leash according to the present invention; and

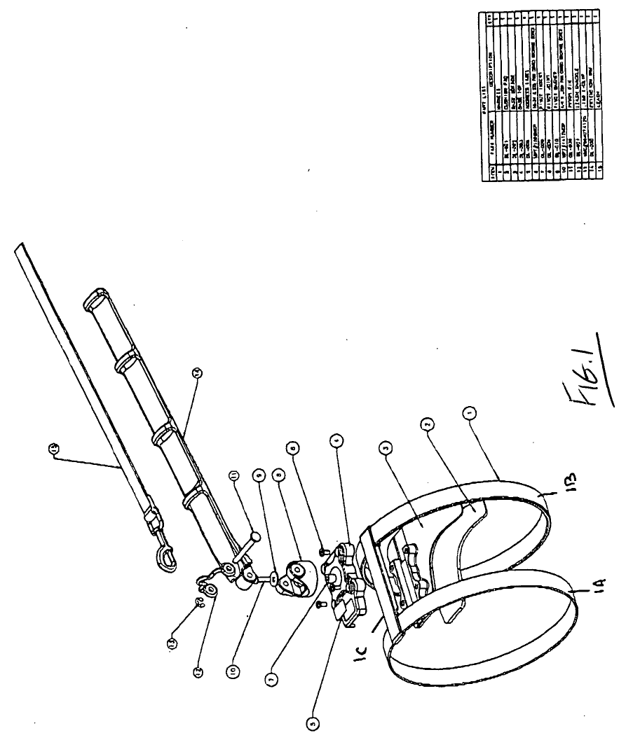

FIG. 2 is an exploded perspective view thereof.

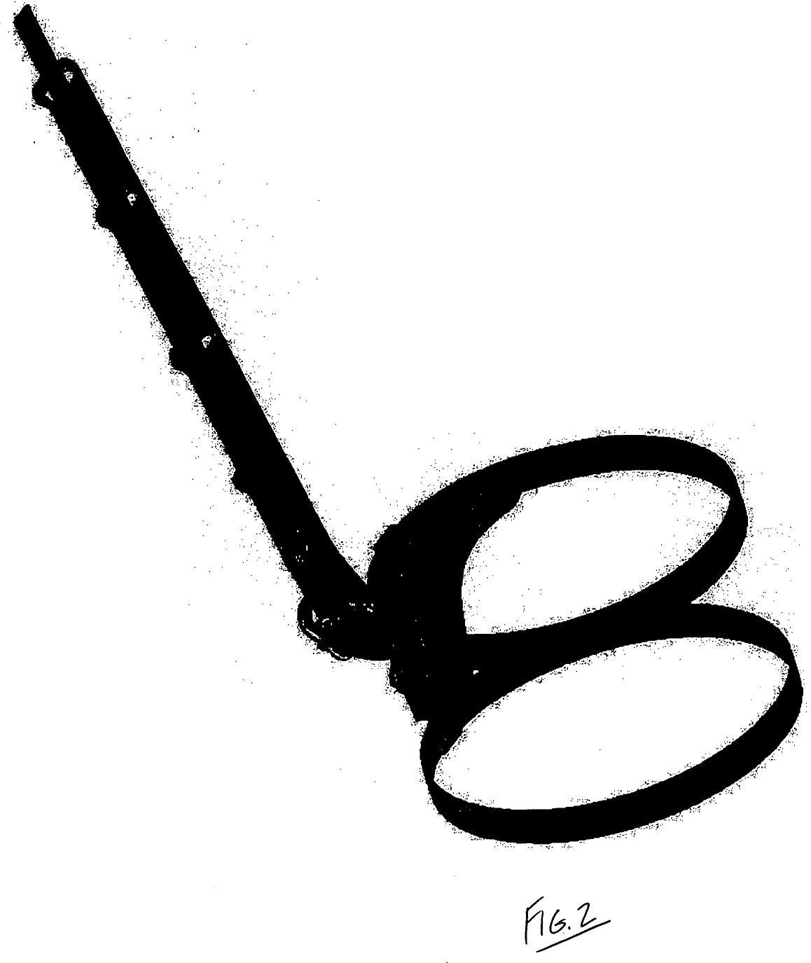

### DETAILED DESCRIPTION OF THE PREFERRED EMBODIMENTS

The best mode for carrying out the invention is presented in terms of its preferred embodiment, herein depicted within the Figures, wherein a rigid animal harness and leash combination is shown including a harness 1 of the type having a front circumscribing element 1A and a rear circumscribing element 1B connected together by a apex attachment 1C. The apex attachment 1C runs laterally along the top of the harness 1, and a cushion pad 2 is parallel to the apex attachment 1A and aligns a lower surface of a base bottom 3 to cushion the animal wearing the harness 1 from any frictional impingement caused by the leash attachment means. A base top 4 connects to the base bottom 3 in a manner to sandwich the apex attachment 1C there between. The base bottom 3 is affixed to the base top 4 by a plurality of fasteners 6. As an additional feature ancillary to the teachings of the present invention, an address label 5 is accommodate upon the base top 4.

Extending upward from the base top 4 is a pivot insert 7, that pivotally attaches to a pivot joint 8. The pivot joint 8 is retained atop of the pivot insert 7 by a retention means, shown herein as a pivot washer 9 and machine screw fastener 10 combination. A leash shackle 12 is attached in a vertically rotatable manner to the top of the pivot joint 8 by a pivot pin 11. The pivot pin 11 is retained onto the leash shackle 12 by a retention clip 13. An extension arm 13 if further attached in a vertically rotatable manner to the top of the pivot joint 8 by a pivot pin 11. In this manner, a leash 15 can be affixed to the leash shackle 12 and threaded onto the extension arm 14 where it will be supported in a rigid, extended manner that easily pivots and swivels in all directions about the harness 1.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents. Therefore, the scope of the invention is to be limited only by the following claims.

1. An animal harness and leash combination comprising:
an animal harness for circumscribing the torso of an animal;
a pivoting leash attachment means affixed to the upper portion of said animal harness;
an extension arm rotatably affixed to said pivoting attachments; and, in combination
a leash;
wherein said leash is capable of being removably attached to said pivoting attachment means and supported on and by said extension arm.

2. The animal harness and leash combination of claim 1, wherein said harness comprises:
a front circumscribing element;
a rear circumscribing element;
an apex attachment connecting said front circumscribing element to said rear circumscribing element laterally along a top of said harness and supporting said pivoting attachment means.

3. The animal harness and leash combination of claim 2, wherein said harness further comprises a cushion pad parallel to said apex attachment and aligned to a lower surface of a base bottom to cushion the animal wearing the harness from any frictional impingement caused by the leash attachment means.

4. The animal harness and leash combination of claim 3, wherein said base top connects to the base bottom in a manner to sandwich said apex attachment there between.

5. The animal harness and leash combination of claim 4, further comprising an address label accommodate upon said base top.

6. The animal harness and leash combination of claim 4, wherein a pivot insert extends upward from said base top at a pivot joint retained atop of said pivot insert by a retention means.

7. The animal harness and leash combination of claim 6, wherein a leash shackle is attached in a vertically rotatable manner to the top of said pivot joint.

8. The animal harness and leash combination of claim 7, wherein an extension arm is further attached in a vertically rotatable manner to the top of said pivot joint, whereby said leash can be affixed to said leash shackle and threaded onto said extension arm 1 here it will be supported in a rigid, extended manner that easily pivots and swivels in all directions about said harness.
